(19) United States
(12) Patent Application Publication
(10) Pub. No.: US 2014/0134319 A1
(43) Pub. Date: May 15, 2014

(54) PROCESSED MEAT PRODUCT WITHOUT ADDED PHOSPHATE, AND METHOD OF PRODUCING SAME

(71) Applicants: Kwang Nam Ko, Seoul (KR); Eun Jung Lee, Seoul (KR); Hyon Ho Baek, Incheon-Si (KR); Min Gyu Song, Seoul (KR); Jyung Hee Jeon, Incheon-Si (KR); Yu Ri Jung, Incheon-Si (KR); Kyung Hee Cho, Incheon-Si (KR); Eun Ji Lim, Daegu-Si (KR)

(72) Inventors: Kwang Nam Ko, Seoul (KR); Eun Jung Lee, Seoul (KR); Hyon Ho Baek, Incheon-Si (KR); Min Gyu Song, Seoul (KR); Jyung Hee Jeon, Incheon-Si (KR); Yu Ri Jung, Incheon-Si (KR); Kyung Hee Cho, Incheon-Si (KR); Eun Ji Lim, Daegu-Si (KR)

(73) Assignee: SAMSUNG FINE CHEMICALS CO., LTD, Ulsan-Si (KR)

(21) Appl. No.: 14/130,952

(22) PCT Filed: Jul. 31, 2012
(86) PCT No.: PCT/KR2012/006095

§ 371 Date: Jan. 6, 2014

(30) Foreign Application Priority Data
Sep. 22, 2011 (KR) 10-2011-0095834

(51) Int. Cl. A23L 1/314

(52) U.S. Cl. CPC A23L 1/31463
USPC 426/646

(57) ABSTRACT

The present invention relates to a processed meat product (sausage and ham) having no added phosphate, which is a harmful ingredient to humans and is used in processes for producing processed meat products, and to a method for producing same. According to the present invention, the pH of ground raw meat is raised to increase the water retention thereof, and a basic pH control agent, alone or combined with a hydrocolloid, is used as a substituting means for phosphate in order to improve syneresis and texture. According to the present invention, a processed meat product having added phosphate may be provided having improved quality without including phosphate.

### TECHNICAL FIELD

The present invention relates to a technology which substitutes for the use of phosphate which sparks controversy over harmful effects on humans and is used in processes for producing processed meat products (sausage and ham).

### BACKGROUND ART

Studies on processed meat products such as sausage have been focused on reducing animal fats or reducing phosphate or table salt in order to prevent obesity accompanied by westernized eating habits presently and adult diseases resulting from obesity.

In commercially available processed meat products, various materials such as phosphates, a hydrocolloid, starch and wheat flour are used in order to adjust the pH and enhance texture. These additive materials enhance texture, moisture retention capacity, flavor and the like of processed meat products.

Phosphate enhances the tenderness and texture by increasing the binding property of the food surimi products with inorganic compounds, brings about harmony of tastes and enhancement in flavors by increasing the water holding capacity and expansibility of food to improve the structure, and prevents spoilage and discoloration. These functional enhancements are caused by transformation of protein structures and extraction of salt-soluble proteins by raising the pH due to addition of phosphate. In particular, phosphate enhances water holding capacity in processed meat products. As the postmortem glycolysis proceeds, the pH of raw meat is decreased, and thus the moisture-holding capacity of myofibrillar proteins is decreased. Therefore, water holding capacity thereof is enhanced by adding phosphate, which may serve to raise the pH, to the processing process. When phosphate is not added, water may not be added as well as quality of a processed meat product deteriorates due to syneresis of raw meat during the production of the product, thereby significantly affecting imparting functionality by other additive materials. However, as described above, phosphate is a harmful ingredient to humans, and therefore, studies have been conducted on development of processed meat products, which restricts the use thereof.

### DETAILED DESCRIPTION OF THE INVENTION

### Technical Problem

The present invention has been made in an effort to provide a substituting means for phosphate, which is a harmful ingredient and is used in processes for producing processed meat products. That is, the present invention has been made in an effort to provide a method for producing a processed meat product in which phosphate is not used.

The present invention has also been made in an effort to provide a processed meat product having no added phosphate, in which water holding capacity is enhanced and qualities such as a syneresis rate and texture are improved, by such a means.

### Technical Solution

The present invention provides a processed meat product including one or more basic pH control agents selected from the group consisting of sodium hydroxide, sodium carbonate, quick lime and slaked lime in an amount from 0.1 to 1.0 wt % based on a weight of raw meat.

When 0.1 to 1.0 wt % of the basic pH control agent is added to the raw material, the pH of the product is preferably in a range from 6.0 to 8.0.

Preferably, the processed meat product of the present invention includes a hydrocolloid in an amount from 0.1 to 1.0 wt % based on the weight of the raw meat.

Preferably, the hydrocolloid is one or more selected from the group consisting of hydroxypropyl methyl cellulose (HPMC), xanthan gum, alginate, carrageenan gum, locust bean gum, tar gum, guar gum, gellan gum, Arabic gum, pectin and agar.

Preferably, the hydrocolloid is a hydroxypropyl methyl cellulose having a methoxy substituent content from 19 to 32 wt % and a hydroxypropoxy substituent content from 4 to 12 wt % and having a viscosity from 3 to 200,000 cps.

The present invention provides a method for producing a processed meat product, the method including: (1) grinding raw meat; (2) introducing one or more basic pH control agents selected from the group consisting of sodium hydroxide, sodium carbonate, quick lime and slaked lime in an amount from 0.1 to 1.0 wt % based on a weight of the raw meat into the ground raw meat and mixing the mixture; (3) aging the mixed meat; (4) introducing a texture enhancer, fat, water or a preservative into the aged and mixed meat and mixing the mixture; and (5) performing a post treatment.

Preferably, the basic pH control agent may be introduced and mixed together with a hydrocolloid in an amount from 0.1 to 1.0 wt % based on the weight of the raw meat.

Preferably, the hydrocolloid is one or more selected from the group consisting of hydroxypropyl methyl cellulose (HPMC), xanthan gum, alginate, carrageenan gum, locust bean gum, tar gum, guar gum, gellan gum, Arabic gum, pectin and agar.

Preferably, as the texture enhancer, hydroxypropyl methyl cellulose (HPMC) is used in an amount from 0.1 to 1.0 wt % based on the weight of the raw meat.

Preferably, the hydroxypropyl methyl cellulose has a methoxy substituent content from 19 to 32 wt % and a hydroxypropoxy substituent content from 4 to 12 wt % and has a viscosity from 3 to 200,000 cps.

### Advantageous Effects

According to the present invention, it is possible to provide a processed meat product having no added phosphate, in which a phosphate ingredient, which is harmful to humans, is not included, water holding capacity is enhanced, and qualities such as a syneresis rate and texture are improved.

### BRIEF DESCRIPTION OF DRAWINGS

FIG. 1 is a flowchart illustrating an exemplary embodiment of a method for producing a processed meat product according to the present invention.

### BEST MODE

The present invention provides a processed meat product including a basic pH control agent which substitutes for phosphate, and a method for producing the same.

The processed meat product of the present invention includes one or more basic pH control agents selected from the group consisting of sodium hydroxide, sodium carbonate, quick lime and slaked lime in an amount from 0.1 to 1.0 wt % based on the weight of raw meat.

The basic pH control agent is a basic material which may enhance the pH in processes for producing processed meat products to prevent the leakage of moisture from the raw meat. As the storage period is increased, the pH of raw meat is decreased by glycolysis and muscle proteins become stiff as postmortem rigidity, thereby reducing the initially retained moisture content from about 90% to about 60%. In order to prevent the reduction in moisture, it is possible to reduce the postmortem rigidity and prevent the loss of moisture by raising the pH to separate the actomysin bonds and secure the filament lattice space of proteins. Further, the greater the pH difference is, the higher the solubility of salt-soluble proteins which have crucial effects on the binding capacity of processed meat products, and an increase in pH through the addition of a basic pH control agent leads to an increase in the amount of salt-soluble proteins extracted.

In the present invention, sodium hydroxide, sodium carbonate, quick lime or slaked lime may be used as the basic pH control agent, but the basic pH control agent is not limited thereto. In particular, sodium carbonate, which is used as an exemplary embodiment of the basic pH control agent in the present invention, significantly enhances water holding capacity of the processed meat product as compared to phosphate which has been used in the related art, and brings about excellent results even in terms of improvements in a syneresis rate and texture.

The basic pH control agent is preferably used in an amount from 0.1 to 1.0 wt % based on the weight of the raw meat. When the basic pH control agent is used in the above-described range, the pH of the product is adjusted to preferably 6.0 to 8.0. When the basic pH control agent is used in an amount less than 0.1 wt %, the pH adjustment is not sufficient to reach a preferred level in processes for producing the product, and escape of moisture from the raw meat occurs. In addition, syneresis and water holding capacity of the produced product are reduced and the mouthfeel deteriorates. On the contrary, when the basic pH control agent is used in an amount more than 1 wt % based on the weight of the raw meat, the pH is raised more than needed and there is a problem in that the product may not be produced.

In the present invention, a hydrocolloid is used together with the basic pH control agent such that the hydrocolloid may serve to assist in the action of the basic pH control agent and further enhance the function thereof. As the hydrocolloid, hydroxypropyl methyl cellulose (HPMC), xanthan gum, alginate, carrageenan gum, locust bean gum, tar gum, guar gum, gellan gum, Arabic gum, pectin or agar may be preferably used.

In particular, the hydroxypropyl methyl cellulose (HPMC), which is used as the hydrocolloid in an exemplary embodiment of the present invention, is a compound represented by the following Formula 1 and has a structure in which a cellulose as a main chain is substituted with H, —CH₃ and —CH₂CH(CH₃)OH as a substituent group R.

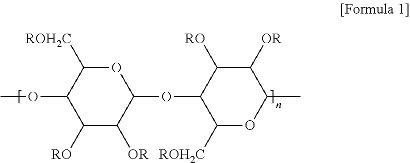

Physicochemical properties of the hydroxypropyl methyl cellulose (HPMC) have a relationship with i) a content of the —OCH₃ substituent, i) a content of the —OCH₂CH(CH₃)OH substituent, and iii) a molecular weight. In the present invention, a hydroxypropyl methyl cellulose having a methoxy substituent content from 19 to 32 wt % and a hydroxypropoxy substituent content from 4 to 12 wt % and having a viscosity from 3 to 200,000 cps is used.

The term “substituent content” means a ratio of a weight of the corresponding substituent to the total weight of the hydroxypropyl methyl cellulose. Furthermore, the viscosity of the hydroxypropyl methyl cellulose is a viscosity measured using a MCR 301 (heating rate: 2° C./min, spindle No.: CC 27 8009, and RPM (shear rate): 1/s) manufactured by Anton Paar Co., Ltd., and means a viscosity of an aqueous hydroxypropyl methyl cellulose solution having a concentration of 2 wt %.

The hydroxypropyl methyl cellulose having the substituent content and the viscosity reduces the escape of moisture during the processing of meats to a preferred level due to “thermal-gelation”. That is, unlike cellulose which is poorly dissolved in water by forming crystals due to strong hydrogen bonding of hydroxyl groups, the hydroxypropyl methyl cellulose exhibits non-ionic properties, has high solubility to water and is well dissolved even at low temperature to form a viscous colloidal solution, and in particular, the hydroxypropyl methyl cellulose exhibits thermal-gelation in which the sol-gel reaction reversibly occurs, unlike other gums or gelatin, which become(s) a solution at high temperature and a gel at low temperature.

Accordingly, when the hydroxypropyl methyl cellulose is used together with a basic pH control agent, the escape of moisture occurring during heating of meat is reduced by the thermal-gelation without disturbing the action thereof, and the water holding capacity of a processed meat product finally produced is enhanced.

In the processed meat product of the present invention, the hydrocolloid also acts as a texture enhancer, and even in this case, hydroxypropyl methyl cellulose acts as a texture enhancer which brings about more enhanced results than other hydrocolloid compounds in terms of hardness and springiness of a product.

In order to optimally enhance the water holding capacity of the processed meat product, the hydrocolloid is preferably used in a range from 0.1 to 1.0 wt % based on the weight of the raw meat. That is, when the hydrocolloid is used in an amount less than 0.1 wt % based on the weight of the raw meat, the water holding capacity thereof is decreased, and on the contrary, when the hydrocolloid is used in an amount more than 1.0 wt % based on the weight of the raw meat, the water holding capacity thereof is increased, but is not much improved as compared to an optimal value. Further, when the hydrocolloid is used in excess, there is a problem in that a large load occurs during the mixing of the mixture, and therefore, the workability deteriorates.

The present invention provides a method for producing a processed meat product, the method including: grinding raw meat; introducing one or more basic pH control agents selected from the group consisting of sodium hydroxide, sodium carbonate, quick lime and slaked lime in an amount from 0.1 to 1.0 wt % based on the weight of the raw meat into the ground raw meat and mixing the mixture; aging the mixed meat; introducing a texture enhancer, fat, water or a preservative in the aged and mixed meat and mixing the mixture; and finally performing a post treatment.

The basic pH control agent may be introduced together with an auxiliary material, such as table salt and nitrite, which is used in the production of a typical processed meat product. In this case, preferably, table salt and nitrite may be used in an amount from 0.1 to 5 wt % and from 0.01 to 0.03 wt % based on the weight of the raw meat, respectively.

The basic pH control agent assists in extraction of salt-soluble proteins in the aging process subsequently performed, thereby increasing the binding capacity and water holding capacity of the raw meat. In this case, when used together with the basic pH control agent, the hydrocolloid brings about a result of further enhancing the water holding capacity by assisting in the action of the basic pH control agent.

As the hydrocolloid, it is possible to use hydroxypropyl methyl cellulose (HPMC), xanthan gum, alginate, carrageenan gum, locust bean gum, tar gum, guar gum, gellan gum, Arabic gum, pectin or agar.

The aging process, which is conducted after the basic pH control agent is introduced and mixed, or the basic control agent and the hydrocolloid are introduced and mixed together, is performed at a cooling temperature from 0 to 5° C., and the aging time is adjusted depending on the amount of meat, and is preferably 12 to 24 hours. Through the aging process, water holding capacity, binding capacity and flavors are improved.

It is all possible to introduce the hydrocolloid before or after the aging process. That is, the basic pH control agent and the hydrocolloid may be introduced before the aging process, thereby assisting in the action of the basic pH control agent in the aging process, or the hydrocolloid may be separately introduced after the aging process is completed, thereby contributing to enhancing mouthfeel of the product.

It is particularly preferred that the hydroxypropyl methyl cellulose as the hydrocolloid is used in terms of effects of improving the texture of the product. In addition, it is preferred that the hydrocolloid is used in an amount from 0.1 to 1.0 wt % based on the weight of the raw meat, such that the hydrocolloid may assists in the action of the basic pH control agent to advantageously act to enhance the water holding capacity, or brings about a preferred effect on improvement in texture of the product, such as hardness and springiness of the product.

Meanwhile, in the present invention, as the texture enhancer, it is possible to use a material, such as isolated soy protein or whey powder, which is used in the production of a typical processed meat product, in addition to the hydrocolloid. In this case, preferably, the isolated soy protein and the whey powder may be used in a range from 0.5 to 5 wt % and from 0.1 to 1 wt % based on the weight of the raw meat, respectively.

After the aging process, iced water, fat and a preservative are additionally introduced. As the raw meat in the production of the processed meat product of the present invention, pork ham part or back fat typically used in the production of a processed meat product is used. In this case, a ham part is usually used as the raw meat which is mixed with the basic pH control agent in the initial stage of the production process, and back fat may be used as the raw meat which is additionally introduced after the aging process. Furthermore, iced water and a preservative are preferably introduced together with back fat. In this case, iced water is used in an amount from 5 to 20 wt % based on the weight of the raw meat, and as the preservative, sodium lactate may be used in a range from 0.1 to 1 wt % based on the weight of the raw meat. Further, in this step, various spices or food additives may be additionally introduced and mixed.

The post treatment process includes: introducing the mixture into a filling machine and filling a casing with the mixture; heat-drying the filled sausage semi-finished product; and cooling the sausage subjected to the heat-drying treatment. In this case, temperature and time for performing the process in each step follow conditions used in typical processes for producing processed meat products.

As an exemplary embodiment of the process of producing a processed meat product having no added phosphate, the present invention provides a method for producing a sausage having no added phosphate, which is conducted under the following conditions.

(1) Pork ham parts and back fat are repeatedly ground twice with a 6-mm plate using a chopper;

(2) Table salt, nitrite and a basic pH control agent are sequentially introduced into the ground ham part, and the mixture is mixed in a silent cutter for 1 to 10 minutes;

(3) The mixed meat is aged in a refrigerator for 24 hours;

Isolated soy protein, whey powder and a hydrocolloid are sequentially introduced into the aged and mixed meat, and the mixture is mixed in a silent cutter for 1 to 10 minutes;

(5) Ground back fat, iced water and sodium lactate are sequentially introduced into the mixture, and the resulting mixture is mixed in a silent cutter for 1 to 10 minutes;

(6) The mixture is introduced into a filling machine and the PVC casing is filled with the mixture;

(7) The filled sausage semi-finished product is heat-dried in a dryer at 60° C. for 60 minutes, and then is heated at 85° C. for 120 minutes; and

(8) The production of the sausage having no added phosphate is completed by cooling the sausage subjected to the heating treatment in iced water for 20 minutes.

In process (5), various spices or additives added in the typical production of a sausage may be additionally introduced.

When a process of infiltrating smoke into the mixture using a smoker is additionally included between processes (4) and (5), a unique smoked aroma produced by reaction of phenols and carbonyls with meat proteins is imparted to the sausage, the appetite is whetted, and a shelf life of the sausage may be enhanced due to bacteriostatic action and antioxidant action caused by phenols.

The casing used in process (6) is characterized by being selected from casings required in various sausages and filled. The size and shape of the casing is determined depending on the type of sausage, and both natural casings and artificial casings may be used and are determined depending on the needs of consumers.

Hereinafter, the present invention will be described in more detail through the Examples. These Examples are provided for illustrating the present invention, and the scope of the present invention should not be understood to be limited thereto.

### Example 1

### Production of Sausage Having No Added Phosphate

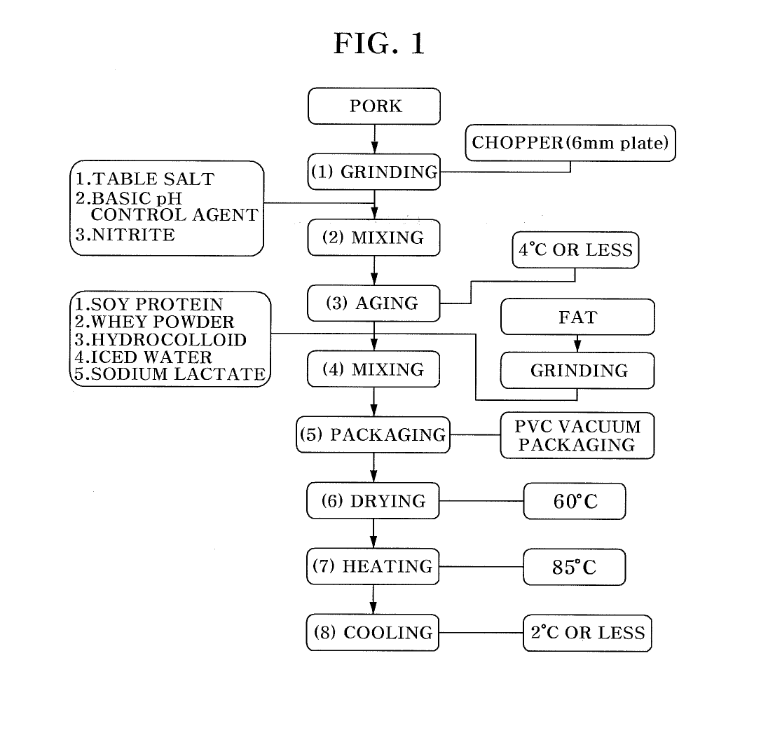

In order to produce a sausage having no added phosphate according to the present invention, raw meat and auxiliary materials were prepared, and then the sausage was produced according to the processes illustrated in FIG. 1.

Pork ham parts, back fat, iced water, table salt, sodium carbonate, nitrite, isolated soy protein, whey powder, hydroxypropyl methyl cellulose (HPMC) and sodium lactate in the entire raw material of the sausage were used in the amounts as described in the following Table 1. As the HPMC, an HPMC prepared by the method described in Korean Patent Application Laid-Open No. 10-2010-0118800 (Cellulose Ether Derivatives and Method of Preparing Same) was used.

A ground meat was prepared by grinding pork ham parts and back fat with excessive fat tissues removed twice with a 6-mm plate using a chopper [meat chopper (M-12S manufactured by Fujee Industries Co., Ltd.)], and an emulsion was prepared by adding the ham parts, table salt, sodium carbonate and nitrite using a silent cutter (Hobart), and then aged in a refrigerator for 24 hours. A mixture was prepared by adding isolated soy protein, whey powder, and hydroxypropyl methyl cellulose to the aged emulsion, performing mixing in a silent cutter, and then adding additionally ground back fat, iced water and sodium lactate thereto. A L. F. Width 55 mm PVC casing was filled with the mixture thus-prepared using a sausage filling machine. Thereafter, the sausage was dried in a dry oven at 60° C. for 1 hour, and then heated at 85° C. for 2 hours using a thermostat water bath (DAIHAN Scientific WCR-22). The heated sausage was finally cooled in iced water for 20 minutes.

### Example 2

A sausage was produced in the same manner as in Example 1, except that sodium carbonate was used in an amount increased by 50% as compared to the amount used in Example 1.

### Example 3

A sausage was produced in the same manner as in Example 1, except that sodium carbonate was used in an amount increased by 100% as compared to the amount used in Example 1.

### Example 4

A sausage was produced in the same manner as in Example 3, except that kappa-carrageenan was used instead of hydroxypropyl methyl cellulose.

### Comparative Example

A sausage was produced in the same manner as in Example 1, except that in Example 1, phosphate was used instead of sodium carbonate and kappa-carrageenan was used instead of hydroxypropyl methyl cellulose.

TABLE 1

| | | | Blending ratio (in batch) | | | | |
|---|---|---|---|---|---|---|---|
| | | | Comparative | Example | Example | Example | Example |
| | | | Example | 1 | 2 | 3 | 4 |
| Raw meat (g) | Pork ham part | | 900 | | | | |
| | Pork back fat | | 100 | | | | |
| Auxiliary materials | Iced water | | 15 | | | | |
| (wt % based on the | Table salt | | 1 | | | | |
| weight of the raw | Phosphate | | 0.3 | — | — | — | — |
| meat) | Sodium carbonate | | — | 0.3 | 0.45 | 0.6 | 0.6 |
| | Hydrocolloid | kappa- | 0.3 | — | — | — | 0.3 |
| | | carrageenan | | | | | |
| | | HPMC | | 0.3 | 0.3 | 0.3 | |

| | |
|---|---|
| Nitrite | 0.03 |
| Isolated soy protein | 1 |
| Whey powder | 0.4 |
| Sodium lactate | 0.5 |

### Experimental Example 1

### Evaluation of Syneresis Rate

In order to evaluate the synereis of the sausages produced in the Examples and the Comparative Example, samples were left to stand at 20° C. for 3 hours. The weights of the sausages were primarily measured, syneresis materials between the sausage casings and the sausages were removed, and then the weights were measured again.

The syneresis rate was derived as in the following equation.

Syneresis rate (%)={(weight of sausage−weight after syneresis materials are removed)/weight of sausage}×100

The result of measuring the syneresis rates is shown in the following Table 2.

TABLE 2

| | Comparative | | | | |
|---|---|---|---|---|---|
| | Example | Example 1 | Example 2 | Example 3 | Example 4 |
| Syneresis (%) | 7.60 ± 3.44 | 1.84 ± 1.01 | 0.92 ± 0.86 | 0.52 ± 0.13 | 0.27 ± 0.09 |

All the values are an average±a standard deviation.

From the above Table, it can be confirmed that when the sodium carbonate of the present invention is used as a basic pH control agent, the syneresis rate was significantly reduced as compared to the Comparative Example in which phosphate was used. In addition, as the amount of sodium carbonate added is increased, the syneresis rate is further reduced. Meanwhile, in the case of the hydrocolloid, kappa-carrageenan exhibited a lower syneresis rate than HPMC.

### Experimental Example 2

### Evaluation of Water Holding Capacity

In order to evaluate the water holding capacities of sausages produced in the Examples and the Comparative Example, samples were left to stand at 20° C. for 3 hours. After the samples were left to stand on an ADVANTEC 2 90-mm filter paper at 20° C. for 3 hours, sausages cut into a 2 cm unit were placed thereon and a 3 kg weight was placed thereon for 5 minutes, and then the total areas on which moisture was dispersed were measured.

In order to evaluate the water holding capacity, an extract-release ratio (ERR) was calculated using the following method.

ERR(%)={(Total area−Area of sausage)/Total area}×100

The results are shown in the following Table 3.

TABLE 3

| | Comparative | | | | |
|---|---|---|---|---|---|
| | Example | Example 1 | Example 2 | Example 3 | Example 4 |
| ERR (%) | 43.50 ± 3.77 | 17.04 ± 1.01 | 11.45 ± 2.33 | 9.15 ± 3.83 | 13.49 ± 0.55 |

All the values are an average±a standard deviation.

According to the ERR measurement results, it can be confirmed that when the sodium carbonate of the present invention was used as a basic pH control agent, water holding capacities were significantly enhanced as compared to the Comparative Example in which phosphate was used. Further, the water holding capacities was further enhanced in proportion to the amount of sodium carbonate used. Meanwhile, in the case of the hydrocolloid, it can be seen that HPMC enhances water holding capacity as compared to kappa-carrageenan.

### Experimental Example 3

### Texture Profile Analysis (TPA)

In order to evaluate the textures of the sausages produced in the Examples and the Comparative Example, samples were left to stand at 20° C. for 3 hours.

Sausages were uniformly cut with a height of about 2 cm, and then a TPA was performed using a 5 kg load cell of TAXTplus (Stable Micro Systems).

Setting Conditions (TPA Probe and Setting) for Texture Profile Analysis (TPA)

: P75 & Pre-test speed <3 mm/sec>, Test speed <1 mm/sec>, Post-test speed <1 mm/sec>, Target mode <Strain> Strain <20%), Time interval <2 sec>, Trigger type <auto>, Trigger force <10 g>, Break mode <off>, Tare mode <auto>, Acquisition rate <500>, & Parameter <dia. 35 mm/height 20 mm>

The results are shown in the following Table 4.

TABLE 4

| | Comparative | | | | |
|---|---|---|---|---|---|
| | Example | Example 1 | Example 2 | Example 3 | Example 4 |
| Hardness | 4137.23 ± 118.44 | 3152.44 ± 225.64 | 2937.90 ± 195.66 | 2793.13 ± 223.37 | 3376.13 ± 211.36 |
| Springiness | 0.8416 ± 0.002 | 0.854 ± 0.007 | 0.862 ± 0.002 | 0.863 ± 0.005 | 0.857 ± 0.003 |

According to the results of the TPA, it was confirmed that the sausages in which the sodium carbonate of the present invention was used exhibited a decrease in hardness and an increase in springiness as compared to the sausage in Comparative Example. That is, the sausages of the present invention exhibited an improved texture as compared to Comparative Example. In addition, as the amount of sodium carbonate added was increased, further improved texture was exhibited. Meanwhile, when kappa-carrageenan was added instead of HPMC as the hydrocolloid, springiness was somewhat decreased, but the value was higher than that when HPMC was used in terms of hardness. That is, HPMC has excellent improvement effects in texture as compared to other hydrocolloids.

### Experimental Example 4

### pH Measurement

In order to evaluate the pHs of the sausages produced in the Examples and the Comparative Example, samples were left to stand at 20° C. for 3 hours. A mixture of 10 g of sausage and 190 g of purified water was ground using a mixer for 30 seconds, and then the pH was measured. The pH was measured using a pH meter SG3-ELK manufactured by Mettler Toledo Co., Ltd.

TABLE 5

| | Comparative | | | | |
|---|---|---|---|---|---|
| | Example | Example 1 | Example 2 | Example 3 | Example 4 |
| pH | 6.53 ± 0.05 | 7.04 ± 0.04 | 7.47 ± 0.04 | 7.82 ± 0.08 | 7.84 ± 0.17 |

All the values are an average±a standard deviation.

From the above Table, it can be seen that sodium carbonate, which is used as a basic pH control agent in the present invention, increased the pH of the product somewhat as compared to phosphate in the Comparative Example, and increased the pH of the product by every 0.43 and 0.35, respectively, (Example 1<Example 2<Example 3) as the use amount thereof was increased by every 50% gradually.

1. A processed meat product comprising:
one or more basic pH control agents selected from the group consisting of sodium hydroxide, sodium carbonate, quick lime and slaked lime in an amount from 0.1 to 1.0 wt % based on a weight of raw meat.

2. The processed meat product of claim 1, wherein the pH is in a range from 6.0 to 8.0 when the basic pH control agent is added in an amount from 0.1 to 1.0 wt % based on the weight of the raw meat.

3. The processed meat product of claim 1, wherein a hydrocolloid is included in an amount from 0.1 to 1.0 wt % based on the weight of the raw meat.

4. The processed meat product of claim 3, wherein the hydrocolloid is one or more selected from the group consisting of hydroxypropyl methyl cellulose (HPMC), xanthan gum, alginate, carrageenan gum, locust bean gum, tar gum, guar gum, gellan gum, Arabic gum, pectin and agar.

5. The processed meat product of claim 3, wherein the hydrocolloid is a hydroxypropyl methyl cellulose having a methoxy substituent content from 1 to 40 wt % and a hydroxypropoxy substituent content from 1 to 30 wt %.

6. A method for producing a processed meat product, the method comprising:
(1) grinding raw meat;
(2) introducing one or more basic pH control agents selected from the group consisting of sodium hydroxide, sodium carbonate, quick lime and slaked lime in an amount from 0.1 to 1.0 wt % based on the weight of the raw meat into the ground raw meat and mixing the mixture;
(3) aging the mixed meat;
(4) introducing a texture enhancer, fat, water or a preservative into the aged and mixed meat and mixing the mixture; and
(5) performing a post treatment.

7. The method of claim 6, wherein the basic pH control agent is introduced and mixed together with a hydrocolloid in an amount from 0.1 to 1.0 wt % based on the weight of the raw meat.

8. The method of claim 7, wherein the hydrocolloid is one or more selected from the group consisting of hydroxypropyl methyl cellulose (HPMC), xanthan gum, alginate, carrageenan gum, locust bean gum, tar gum, guar gum, gellan gum, Arabic gum, pectin and agar.

9. The method of claim 6, wherein as the texture enhancer, hydroxypropyl methyl cellulose (HPMC) is used in an amount from 0.1 to 1.0 wt % based on the weight of the raw meat.

10. The method of claim 9, wherein the hydroxypropyl methyl cellulose has a methoxy substituent content from 19 to 32 wt % and a hydroxypropoxy substituent content from 4 to 12 wt % and has a viscosity from 3 to 200,000 cps.
